(19) United States
(12) Patent Application Publication
(10) Pub. No.: US 2001/0007642 A1
(43) Pub. Date: Jul. 12, 2001

(54) SEALING APPARATUS FOR USE WITH MICROPLATES

(76) Inventor: MARC FEIGLIN, EAST BRUNSWICK, NJ (US)

Correspondence Address: MERCK AND CO INC, P O BOX 2000, RAHWAY, NJ, 070650907

(21) Appl. No.: 09/257,277

(22) Filed: Feb. 24, 1999

Related U.S. Application Data
(60) Provisional application No. 60/076,581, filed on Mar. 3, 1998.

(51) Int. Cl. B01L 3/00

(52) U.S. Cl. 422/102; 422/58; 435/288.5; 435/305.2

(57) ABSTRACT

The present invention relates to a sealing apparatus that effectively seal microplates and can be used in conjunction with automated equipment. While the present invention is adaptable to automated instruments, it does not require sophisticated machinery to utilize the apparatus.

### BACKGROUND OF THE INVENTION

Modern diagnostic medicine depends on the routine testing of biological samples from sources such as blood, serum, spinal fluid, urine, tissue specimens, etc. In addition, many other industries and research facilities run both chemical and biological tests in large numbers. In order to perform the running of large numbers of tests efficiently, accurately, and safely, the “hardware” used in the performance of the tests can be of critical importance.

Microtiter plates or “microplates” were introduced in the 1960's to facilitate laboratory testing in situations where a large number of tests were run simultaneously. Microplates come in various sizes, from 6 to 9600 wells. The most typical microplates contain ninety-six (96) molded plastic wells (in an 8×12 array) with a typical sample volume capacity of about 200 microliters. A wide variety of mechanical fluid handling devices are now available so that specimens, chemical solutions and other liquids can be transferred into the wells. Usually a row of eight (8) or twelve (12) wells are filled simultaneously, but some handling devices can simultaneously add sample to all of the wells. The lids of the microplates are designed to prevent dust or other contaminants from entering the wells, as well as to slow down the rate of evaporation. Usually the lids are sturdy enough so that they can be removed and placed on the microplates by a variety of automated scientific instruments and robotic arms.

The design of the microplate is less than optimal in several ways. Most microplates have loose fitting lids, which are not designed to seal the top of the open wells of the microplates. As a consequence, liquid can spill out of the well or aerosols can form during filling. This can ruin the test and may also create a hazard if the testing involves infectious material.

Because the lids do not create a tight seal there is a tendency for condensation to form from the wells. Over time, this condensation can spread along the lid creating cross-contamination between the samples in the wells. Sealing mats are available that can be used to seal the microplates. The mats are often made of polypropylene or silicone. Such materials create sealing mats that are too thin to be handled by most automated instruments. The polypropylene mats require significant pressure to place and remove them, and the silicone mats are too flimsy for a machine to maneuver them.

It is the object of this invention to provide an inexpensive, easily manufactured sealing apparatus used in conjunction with microplates that is easily adaptable for use by automated instruments.

### SUMMARY OF THE INVENTION

The present invention relates to a sealing apparatus that effectively seal microplates and can be used in conjunction with automated equipment. While the present invention is adaptable to automated instruments, it does not require sophisticated machinery to utilize the apparatus. The types of device which would be capable of manipulating the instant invention include, but are not limited to, laboratory robot arms, such as those from Beckman, CRS Robotics, Mitsubishi Robotics and Zymark. Specific types of laboratory robot arms include, but are not limited to, Tecan Genesis RMP, Rosys Plato 2000 and Beckman Biomek.

The invention relates to a sealing apparatus comprising:

a lid which is designed to be used with microplates, having an outer surface and an inner surface; and

a microplate mat having a top side and a bottom side, the bottom side having multiple protrusions formed thereon which correspond to and seal an array of openings in a microplate, the top side of the microplate mat being attached to the inner surface of the lid.

Still other objects and advantages of the present invention will become readily apparent to those skilled in this art from the following detailed description, wherein only the preferred embodiment of the invention has been shown, simply by way of illustration of the best mode contemplated. As will be realized, the invention is capable of modifications in various aspects, all without departing from the invention. Accordingly, the drawings and description are to be regarded as illustrative in nature, and not as restrictive.

### BRIEF DESCRIPTION OF THE DRAWINGS

The present invention may be described with greater clarity and specifically with reference to the drawings, in which:

FIG. 1 is a view in perspective of the preferred embodiment of the invention;

FIG. 2 is a view in perspective of the microplate mat; and

FIG. 3 is a view in perspective of the microplate lid.

### DETAILED DESCRIPTION OF THE INVENTION

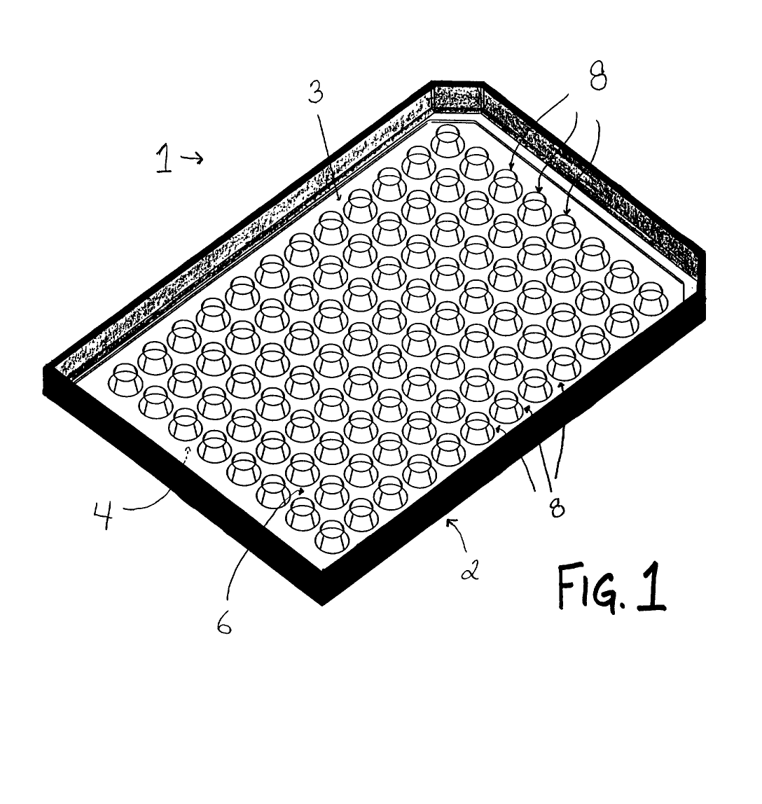

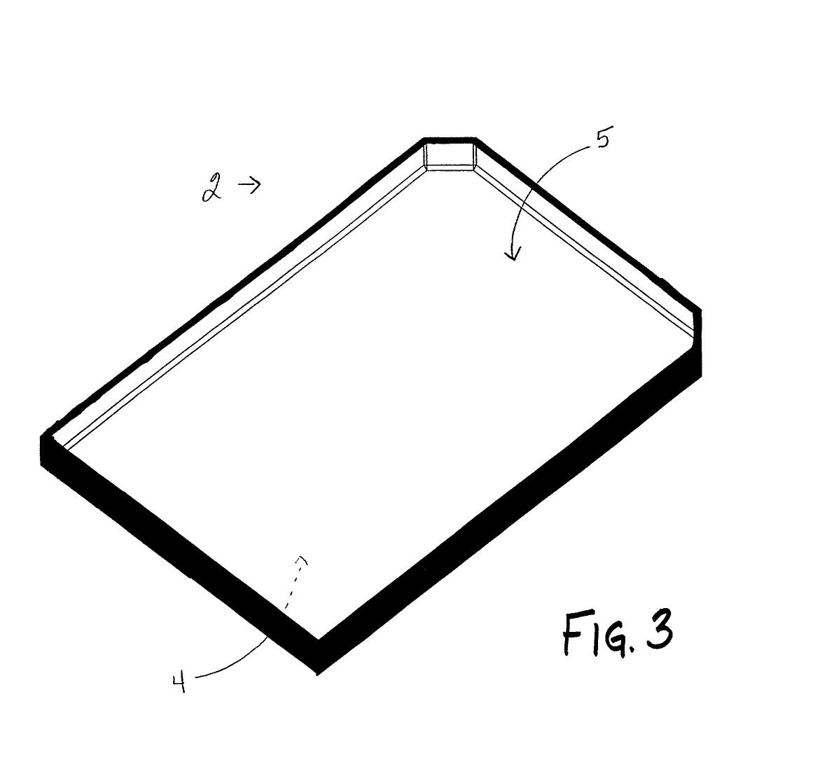

Referring more particularly to the drawings, wherein like numbers designate like parts throughout, FIG. 1 represents the invention, as assembled, in two dimensions. The sealing apparatus (1) comprises a lid (2) and a microplate mat (3). As shown in FIG. 3, the lid (2) has an outer surface (4) and an inner surface (5). The lid (2) is made from a rigid material. Examples of such rigid materials include, but are not limited to, polystrene, polypropylene, polycarbonate or acrylic.

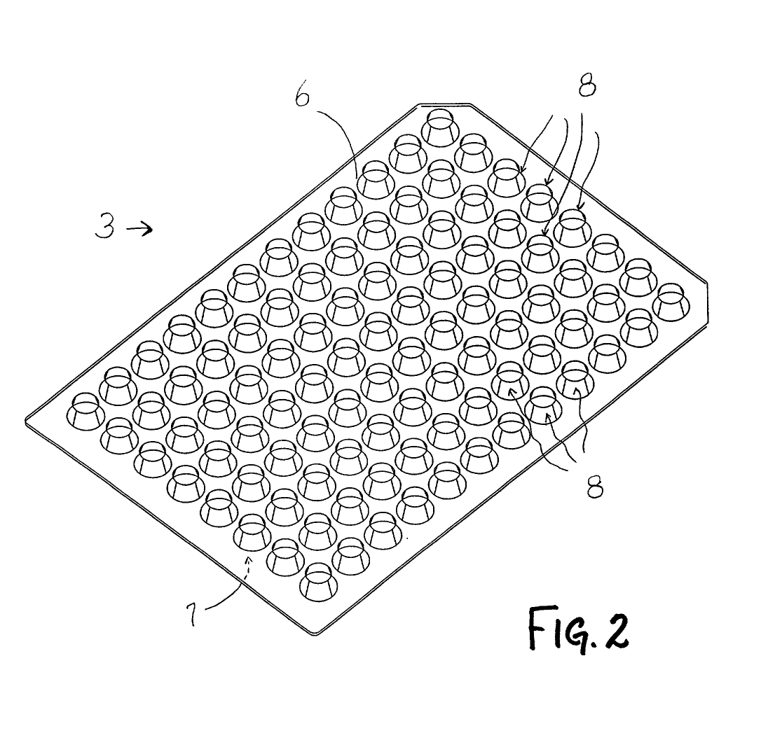

As shown in FIG. 2, the microplate mat (3) has a top side (6) and a bottom side (7). Multiple protrusions (8) are formed on the bottom side (7) of the microplate mat (3). These protrusions (8) correspond to and seal an array of openings found in a microplate. The number of protrusions (8) formed on the mat (3) can vary, depending on the size of the microplate being used. Typically, most mats (3) will contain 6 to 384 protrusions (8). Of course, the number of protusions will dependent on the microplate used and the number of wells in the microplate. The top side (6) of the microplate mat (3) is attached to the inner surface (5) of the lid (2). The microplate mat (3) is made from a flexible material. Examples of such flexible materials include, but are not limited to, silicone, polypropylene, sodium polysulfide, polychloroprene (neoprene), butadienestyrene copolymners (SBR), rubber and the like.

The microplate mat (3) is attached to the inner surface (5) of the lid (2) by using a solvent resistant adhesive appropriate for the materials being joined. Types of solvent resistant adhesives include, but are not limited to, glue or double-sided adhesive tape. Other methods for attaching the microplate mat and the lid, such as molding, heating and other techniques known in the art, may also be used.

In operation, the sealing apparatus (1) is placed on top of a microplate by an automated instrument so that the protrusions (8) sit in the openings of the microplate. When the automated instrument applies the necessary pressure, the protrusions (8) seal the openings of microplate and prevent evaporation or cross-contamination. In a similar manner, the sealing apparatus (1) can be removed from the microplate by a simple lifting action of an automated instrument.

In this disclosure, there is shown and described only the preferred embodiment of the invention, but, as aforementioned, it is to be understood that the invention is capable of changes or modifications within the scope of the inventive concept as expressed herein.

What is claimed is:

1. A sealing apparatus comprising:
a lid which is designed to be used with microplates, having an outer surface; and an inner surface; and
a microplate mat having a top side and a bottom side, the bottom side having multiple protrusions formed thereon which correspond to and seal an array of openings in a microplate, the top side of the microplate mat being attached to the inner surface of the lid.

2. The sealing apparatus of claim 1 wherein the lid is made of non-flexible material comprising polystrene, polypropylene, polycarbonate or acrylic.

3. The sealing apparatus of claim 2 wherein the mat is made of flexible material comprising silicone, polypropylene, sodium polysulfide, polychloroprene (neoprene), butadienestyrene copolymners (SBR), or rubber.

4. The sealing apparatus of claim 3 wherein the mat is attached to the lid with an adhesive comprising glue or double-sided adhesive tape.
